(19) United States
(12) Patent Application Publication
(10) Pub. No.: US 2004/0062624 A1
(43) Pub. Date: Apr. 1, 2004

(54) Vented cold ring, processes, and methods of using

(75) Inventors: Michael J. Aloi, Rio Rancho, NM (US); James D. Graff, Rio Rancho, NM (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/256,121

(22) Filed: Sep. 26, 2002

(51) Int. Cl. F16B 43/00

(52) U.S. Cl. 411/531

(57) ABSTRACT

A chemical vapor deposition (CVD) process employs a vented cold ring. The vented cold ring includes the capability of resisting the movement of a wafer that is being processed during a throttling operation. The vented cold ring also resists the buildup of unwanted deposition during CVD processing.

### TECHNICAL FIELD

Embodiments of the present invention relate to articles and methods that are used in semiconductor processing. More particularly, an embodiment relates to a vented cold ring system that is used during chemical vapor deposition for semiconductor processing.

### BACKGROUND INFORMATION

Description of Related Art

Integrated circuits (ICs) are processed in a high-volume manufacturing scheme by use of expensive processing tools such as a chemical vapor deposition (CVD) chamber. A CVD chamber is useful during several stages of process integration such as for depositing metal films, metal compound films, dielectric films, and others. During extended use, the CVD chamber becomes fouled under ordinary processing conditions. A preventative maintenance (PM) is therefore scheduled, based upon operator experience, such that an optimum number of wafers is processed before the CVD chamber has become too fouled to assure a useful process yield.

When the CVD chamber is taken off-line for a PM, several parts must be cleaned to the level of a pristine new part. PM cleaning is time-consuming, and it often may take 24 hours or longer. However, cleaning of the CVD chamber is unavoidable, and the cleaning process must be undertaken periodically.

During CVD processing, the number of particulates that occur on the wafer has a direct effect on die yield. Accordingly, a cleaner process results in a higher yield, and a periodic cleaning also results in a higher yield.

Known CVD processing technology include a kit such as the TxZ® kit made by Applied Materials, Inc. of Santa Clara, Calif. The TxZ® kit is useful for the advanced integrated processing schemes of devices including 0.35 micron (micrometer) processing, 0.25 micron processing, 0.18 micron processing, 0.15 micron processing, 0.13 micron processing, 0.10 micron processing, and for future-generation processing.

FIG. 1 is a cross-sectional elevation of an existing CVD system. The system 100 includes a heater 110, a wafer chuck 112, and a cold ring 114. The cold ring 114 is seated upon two washer-like rings 116 and 118. A bottom purge is undertaken in which a purge gas (indicated as the meandering flow) 120 is flowed upwardly to counter deposition at unwanted areas. Unwanted deposition occurs as a first deposition 122 at the edge of the wafer chuck 112 and as a second deposition 124 between the heater 110 and the cold ring 114. The first deposition 122 and the second deposition 124 represent decomposed materials from CVD processing.

One undesirable result in CVD processing is that the wafer moves during throttling of process gases. After a significant number of wafers has been processed, such as about 5,000 to 8,000 wafers, a PM must be undertaken to clean the first and second depositions, 122 and 124, respectively.

### BRIEF DESCRIPTION OF THE DRAWINGS

In order to understand the manner in which embodiments of the present invention are obtained, a more particular description of various embodiments of the invention briefly described above will be rendered by reference to the appended drawings. Understanding that these drawings depict only typical embodiments of the invention that are not necessarily drawn to scale and are not therefore to be considered to be limiting of its scope, the embodiments of the invention will be described and explained with additional specificity and detail through the use of the accompanying drawings in which:

FIG. 1 is a cross-sectional elevation of an existing CVD system;

FIG. 2 is an oblique elevation of a vented cold ring according to an embodiment;

FIG. 3A is a schematic elevation of a vented cold ring according to an embodiment;

FIG. 3B is a schematic elevation of a vented cold ring according to an embodiment;

FIG. 3C is a schematic elevation of a vented cold ring according to an embodiment;

FIG. 3D is a schematic elevation of a vented cold ring according to an embodiment;

FIG. 3E is a schematic elevation of a vented cold ring according to an embodiment;

FIG. 4 is a cross-sectional elevation of a vented cold ring system according to an embodiment;

FIG. 5 is a cross-sectional elevation of a vented cold ring system according to an embodiment;

FIG. 6 is a process flow diagram according to an embodiment; and

FIG. 7 is a method flow diagram according to an embodiment.

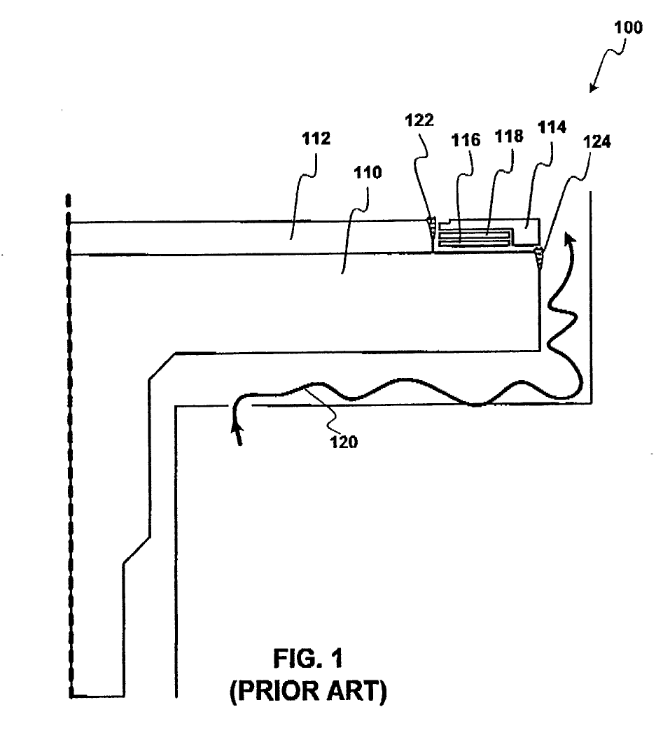

### DETAILED DESCRIPTION

The following description includes terms, such as first, second, etc., that are used for descriptive purposes only and are not to be construed as limiting. In the following detailed description, reference is made to the accompanying drawings, which form a part hereof. These drawings show, by way of illustration, specific embodiments in which the invention may be practiced. In the drawings, like numerals describe substantially similar components throughout the several views. These embodiments are described in sufficient detail to enable those skilled in the art to practice the inventive concepts. Other embodiments may be used, and structural, logical, and electrical changes may be made without departing from the scope of the present invention.

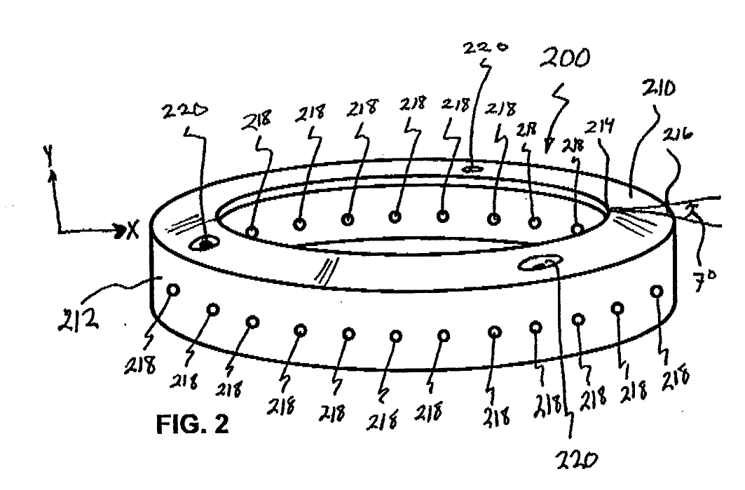

FIG. 2 is an oblique elevation of a vented cold ring according to an embodiment. The vented cold ring 200 includes a washer upper section 210 and an annular lower section 212. In one embodiment, the washer upper section 210 is substantially orthogonal to the annular lower section 212. In another embodiment, the washer upper section 210 has a pitch of about 7° that falls from its inner circumference 214 to its outer circumference 216. Other pitches greater or less than 7° can be selected depending upon the application. The washer upper section 210 includes a characteristic width, and the annular lower section 212 includes a characteristic height. In one embodiment, the characteristic height is greater than the characteristic width. In another embodiment, the characteristic height is smaller than the characteristic width.

At least one through-hole 218 is located on the annular lower section 212. The at least one through-hole 218 is located upon the annular lower section 212 according to its ultimate orientation within a CVD chamber as is discussed below. In one embodiment, the at least one through-hole 218 includes a plurality of through-holes 218. In one embodiment, the plurality of through-holes includes uniformly spaced holes. By “uniformly spaced”, it is meant that the holes are equidistantly spaced on through-hole centers. In one embodiment, the through-holes are uniformly spaced, incrementally sized holes as set forth below.

In one embodiment, a first fastener hole 220 is located in the washer upper section 210. In one embodiment, three occurrences of the first fastener hole 220 are located in the washer upper section 210. Other numbers of the first fastener holes 220 can be used according to a specific application.

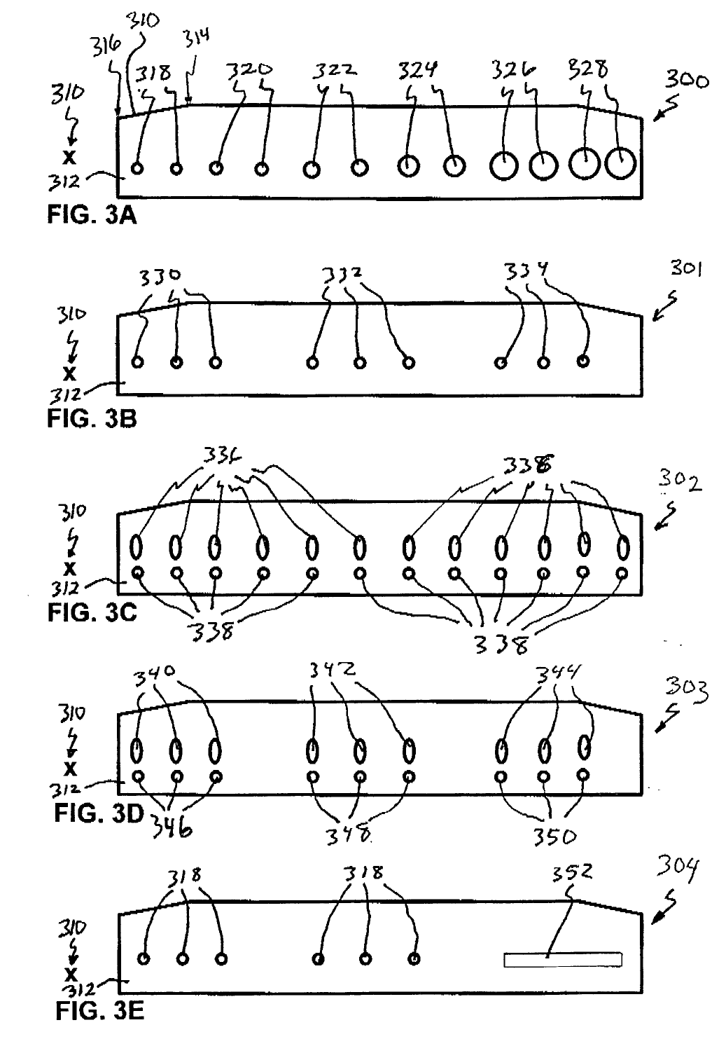

FIGS. 3A-3E represent various embodiments. In one embodiment, the at least one through-hole includes a plurality of through-holes in a range from about 2 to about 100 in number. In another embodiment, the plurality of through-holes is in a range from about 8 to about 80. In another embodiment, the plurality of through-holes is in a range from about 16 to about 40.

FIG. 3A is a schematic elevation of a vented cold ring 300 according to an embodiment. The pitch between the inner circumference 314 and the outer circumference 316 of the washer upper section is also illustrated. As set forth herein, embodiments include an orientation of the vented cold ring in relation to the CVD chamber. Pressure differentials occur within the CVD chamber, particularly during gas flow operations. One source of the pressure differentials is a pump port for managing the flow of process gases. In FIG. 3A, the location of a pump port 310 in relation to the vented cold ring 300 is indicated schematically by the letter X.

According to one embodiment, the at least one through-hole includes a plurality of through-holes. In a non-limiting illustration depicted in FIG. 3A, twelve (12) through-holes (318, 320, 322, 324, 326, and 328, labeled in pairs) are depicted. In this embodiment, the plurality of through-holes includes a plurality of uniformly spaced incrementally sized holes. On the annular lower section 312, through-holes 318 have a standard hole size of ⅛ inch (0.318 centimeter). Through-holes 320 have a standard hole size of 9/64 inch that is sized incrementally larger than through-holes 318. Through-holes 322 have a standard hole size of 9/32 inch (0.714 cm) sized incrementally larger than through-holes 320. Through-holes 324 have a standard hole size of 19/64 inch (0.754 cm) sized incrementally larger than through-holes 322. Through-holes 326 have a standard hole size of 5/16 inch (0.794 cm) sized incrementally larger than through-holes 324. And through-holes 328 have a standard hole size of ¼ inch (0.635 cm) sized incrementally larger than through-holes 326. In one embodiment, the vented cold ring 300 is represented schematically, as all through-holes on half of the circumference are depicted. Accordingly, the vented cold ring 300 has a plurality of through-holes that totals twenty-four (24) through-holes.

FIG. 3B is a schematic elevation of a vented cold ring 301 according to an embodiment. In this embodiment, the plurality of through-holes includes uniformly spaced groups of same-sized holes. By “uniformly spaced, same-sized” it is meant that the groups are uniformly spaced, and among a given group, the holes of the group are same-sized. In accordance with other embodiments, it is understood that an embodiment includes an incidence of fewer through-holes and/or fewer through-hole groups that are placed proximate the location of the pump port 310. Accordingly, the through-holes 330 are a smallest size in FIG. 3B, the through-holes 332 represent an optional at least one intermediate size, and the through-holes 334 represent a largest size. According to another embodiment, the arrangement of the through-holes 330, 332, 334 can be all same-sized holes, but the groups are incrementally clustered to have the greatest clustering at a location that is distal to the location of the pump port 310, and the least clustering is at a location that is proximal to the pump port 310. Other clustering schemes can be selected.

FIG. 3C is a schematic elevation of a vented cold ring 302 according to an embodiment. In FIG. 3C, upper holes 336 and lower holes 338 are arrayed along the annular lower section 312 of the vented cold ring 302. In this embodiment, the through-holes include grouped same-sized holes that are grouped in upper and lower groups. The upper-group holes 336, although they can appear to be uniformly same-sized, can be incrementally sized according to a scheme similar to the embodiment set forth in FIG. 3A. The lower-group holes 338, although they can likewise appear to be uniformly same-sized, can also be incrementally sized according to a scheme similar to the embodiment set forth in FIG. 3A.

Another embodiment includes a combination of uniformly spaced through-holes such as is depicted in FIG. 3A, with upper or lower spaced groups of same-sized holes, such as is depicted in FIG. 3B.

FIG. 3D is a schematic elevation of a vented cold ring 303 according to an embodiment. In this embodiment, the plurality of through-holes includes upper and lower uniformly spaced groups of same-sized holes. By “uniformly spaced, same sized” it is meant that the groups are uniformly spaced, and among a given group, the holes of the group are same-sized. In accordance with other embodiments, it is understood that an embodiment includes an incidence of fewer through-holes and/or fewer through-hole groups that are placed proximate the location of the pump port 310. For the upper holes 340, 342, and 344, the through-holes 340 are a smallest size for the upper holes in FIG. 3D, the through-holes 342 represent an optional at least one intermediate size, and the through-holes 344 represent a largest size. According to another embodiment, the arrangement of the through-holes 340, 342, 344 can be all same-sized holes, but the groups are incrementally clustered to have the greatest clustering at a location that is distal to the location of the pump port 310, and the least clustering is at a location that is proximal to the pump port 310. Other clustering schemes can be selected.

Similarly, for the lower holes 346, 348, and 350, the through-holes 346 are a smallest size for the lower holes in FIG. 3D, the through-holes 348 represent an optional at least one intermediate size, and the through-holes 350 represent a largest size. According to another embodiment, the arrangement of the through-holes 346, 348, and 350 can be all same-sized holes, but the groups are incrementally clustered to have the greatest clustering at a location that is distal to the location of the pump port 310, and the least clustering is at a location that is proximal to the pump port 310. Other clustering schemes can be selected that include clustering upper and lower holes in relation to the location of the pump port 310 as set forth in this disclosure.

FIG. 3E is a schematic elevation of a vented cold ring 304 according to an embodiment. Although a substantially circular through-hole can be an embodiment that is selected, other through-hole shapes are embodiments. In one embodiment, a slot 352 is depicted, in addition to substantially circular holes, represented generically by reference numeral 318. In one embodiment, the slot 352 can be a single through-hole. In one embodiment, a plurality of slots can be formed on the annular lower section 312. In one embodiment, the slot 352 is part of a mixture of holes similar to holes 318.

By the embodiments depicted in FIGS. 3A-3E, it becomes clear that one of ordinary skill in the art can undertake a practical exercise to select a through-hole scheme according to a specific application. It also becomes clear that one of ordinary skill in the art can undertake an academic exercise to select a through-hole scheme according to a specific application.

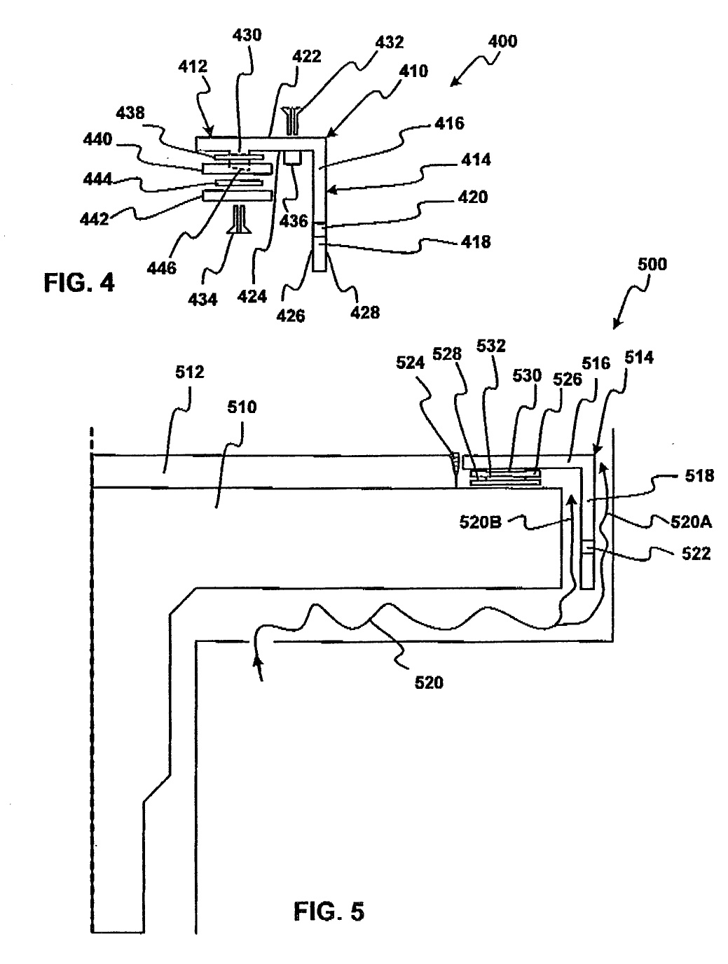

FIG. 4 is a cross-sectional elevation of a vented cold ring system 400 according to an embodiment. The vented cold ring system 400 includes a vented cold ring 410 that includes a washer upper section 412 and an annular lower section 414. The annular lower section 414 can be defined by an upper region 416 and a lower region 418 that is separated by a through-hole 420. The washer upper section 412 and the annular lower section 414 are substantially orthogonal to each other when defined by their major axes that pass through the most mass of each section as illustrated. By “substantially orthogonal” it is understood that the washer upper section 412 can have a pitch that can deviate, for example, by about 7° from the horizontal as depicted in FIG. 2. In one embodiment, the pitch of the washer upper section 412 can have an angle that deviates from the horizontal in a range from about negative 10° to about positive 10°. Unlike the structure depicted in FIG. 2, FIG. 4 depicts a substantially orthogonal configuration with no illustrated pitch.

The washer upper section 412 includes an upper surface 422 and a lower surface 424. The annular lower section 414 includes an inner surface 426 and an outer surface 428. A prominence 430 extends downwardly from the lower surface 424 of the washer upper section 412.

Another embodiment of the vented cold ring system 400 includes an upper fastener 432 and a lower fastener 434. In another embodiment, the upper fastener 432 and the lower fastener 434 are each vented. In one embodiment, at least one of the upper fastener 432 and the lower fastener 434 is vented. Included in the upper fastener system is a fastener seat 436. The fastener seat 436, when assembled with a CVD chamber, contacts a rest button (not pictured) as is known in the art. In one embodiment, the vented cold ring 410 is an aluminum structure. In one embodiment, the fastener seat 436 is a stainless steel structure.

The lower fastener 434 is configured to make closure contact with the prominence 430. In one embodiment, the lower fastener 434 is a threaded vent screw, and the prominence 430 is internally threaded to match threading of the lower fastener 434. With the lower fastener system, a first washer, hereinafter referred to as a first spacer 438, is disposed over the prominence 430. The vented cold ring 410 is seated upon two washer-like rings that include a first support ring 440 and a second support ring 442. The first spacer 438 is disposed between the washer upper section 412 and the first support ring 440. A second washer, hereinafter referred to as a second spacer 444, is disposed between the first support ring 440 and the second support ring 442. The spacer ring 442 has a smaller hole that is countersunk to accept the screw 434. FIG. 4 illustrates one embodiment where the terminal end 446 (depicted by a phantom line) of the prominence 430 terminates within the thickness of the first support ring 440 as depicted. Although the elevational cross section depicted in FIG. 4 is exploded, it is understood in one embodiment that when the cold ring system is fully assembled, the terminal end 446 of the prominence 430 terminates within the thickness of the first support ring 440.

FIG. 5 is a cross-section elevation of a vented cold ring system 500 according to an embodiment. A heater block 510 includes a wafer chuck 512. Prior art heater blocks included complex geometries that required more elaborate cleaning processes. The heater block of this embodiment of the present invention includes a simple, substantially rectilinear geometry. In contrast to known methods and systems for cold rings, no back-side clamping is required in embodiments of the vented cold ring system.

The vented cold ring system 500 includes a vented cold ring 514 that includes a washer upper section 516 and an annular lower section 518. A bottom purge is undertaken in which a purge gas (indicated as the meandering flow) 520 is flowed upwardly to counter deposition at unwanted areas. In this embodiment, the annular lower section 518 acts to split the purge gas 520 into an outer flow 520A and an inner flow 520B. The inner flow 520B substantially bypasses the through-hole 522 due to the equilibrating presence of the outer flow 520A. Unwanted deposition occurs as a first deposition 524 at the edge of the wafer chuck 512.

The vented cold ring 514 is seated upon two washer-like rings that include a first support ring 526 and a second support ring 528. A first washer, hereinafter referred to as a first spacer 530 is disposed between the washer upper section 516 and the first support ring 526. A second washer, hereinafter referred to as a second spacer 532, is disposed between the first support ring 526 and the second support ring 528.

In one embodiment, the vented cold ring system 500 includes an upper fastener and a lower fastener similar to the embodiments depicted in FIG. 4. In another embodiment, the upper fastener and the lower fastener are each vented. In one embodiment, at least one of the upper fastener and the lower fastener is vented. Included in the upper fastener system is a fastener seat similar to the embodiments depicted in FIG. 4.

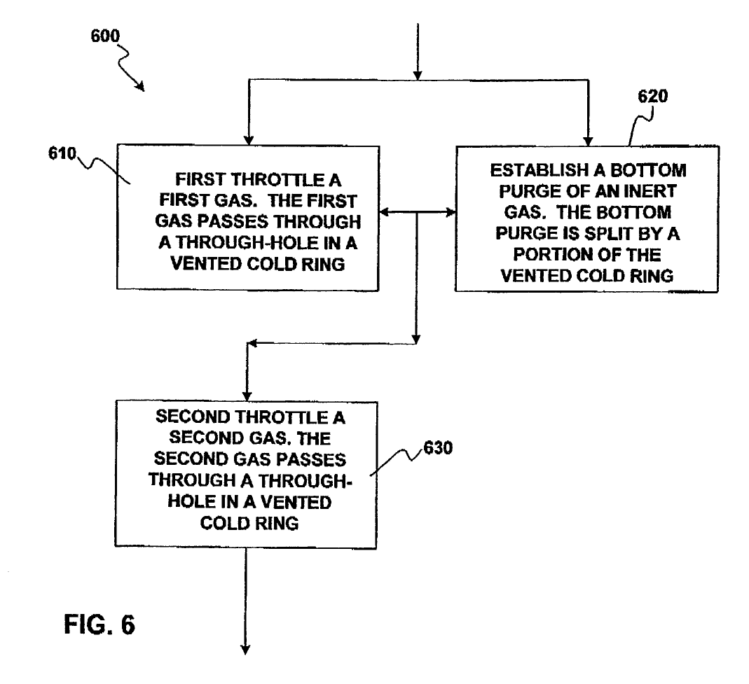

FIG. 6 is a process flow diagram 600 according to an embodiment. According to a process embodiment, the CVD chamber is prepared to a milliTorr atmosphere, often referred to as a “high vacuum.” The wafer resides in a transfer chamber that has been prepared up to an approximate 10⁻⁸ Torr atmosphere, such as by a cryogenic high-vacuum pump. A robot extends into the transfer chamber, the transfer chamber valve closes, and gas begins to flow into the CVD chamber to prepare it for processing.

At 610, the wafer is meanwhile brought to a process position within the CVD chamber, and control is exercised on the CVD chamber to begin throttling the chamber to the CVD pressure. In one embodiment, the CVD process pressure is from about 1.4 Torr to about 1.6 Torr. In another embodiment, the CVD process pressure is about 1.5 Torr.

At 620, during the establishment of gas flow conditions, a bottom purge of an inert gas is also established. The bottom purge is used in a gas flow range from about 20 standard cubic centimeters per minute (sccm) to about 100 sccm. In one embodiment, a 50 sccm purge gas flow rate is used.

During the first throttling, the first gas passes through at least one through-hole in the vented cold ring. By passing through the at least one through-hole in the vented cold ring, the wafer does not move to any significant degree such as it did in previous processes. Once the pressure, temperature, and other processing conditions have been achieved, the CVD gas begins to feed to the CVD chamber.

A refractory metal film can be formed in the CVD process. In one embodiment, a refractory metal compound film is formed. The refractory metal that is used to form one of the refractory metal film or the refractory metal compound film includes at least one metal selected from titanium (Ti), zirconium (Zr), hafnium (Hf), or combinations thereof. In one embodiment, the refractory metal is selected from vanadium (V), niobium (Nb), tantalum (Ta), or combinations thereof. In one embodiment, the refractory metal is selected from chromium (Cr), molybdenum (Mo), tungsten (W), or combinations thereof. In one embodiment, the refractory metal is selected from cobalt (Co), rhodium (Rh), iridium (Ir), or combinations thereof. In one embodiment, the refractory metal is selected from nickel (Ni), palladium (Pd), platinum (Pt), or combinations thereof. In one embodiment, a metal wiring layer is formed. In this embodiment, a metal such as aluminum (Al), copper (Cu), silver (Ag), gold (Au), or the like, is used.

In one embodiment, a metal nitride film is formed. The refractory metals that can be used to form a refractory metal film can be used to form a refractory metal nitride film. In some embodiments a metal such as aluminum (Al) is used.

In one embodiment, the CVD gas is triethylaluminum (TEAL) or the like. In one embodiment, the CVD gas is selected from tetrakisdimethylamino titanium (TDMAT) or tetrakisdiethylamino titanium (TDEAT), or trimethylethylenediamine tris(dimethylamino)titanium (TMEDT), and the like.

The CVD gas is bubbled with an inert gas carrier such as helium. The CVD gas is carried from the bubbling source, through a distributor such as a “shower head”, as is known in the art. A CVD process then occurs in the CVD chamber. After the CVD process, the bottom purge can be discontinued.

In another embodiment, a dielectric film is formed. The dielectric film can include one of an oxide, a nitride, an oxintride, and the like. For example, an oxide film is formed by the decomposition of tetraethylortho silicate (TEOS).

In one embodiment, a semiconductive film is formed. For example, a silicon source such as silane is bubbled to the CVD chamber, and deposition is carried out to form a polysilicon film.

At 630, a second throttling process is carried out. The second throttling process follows the CVD process. During the second throttling, the first gas (at a higher pressure than the second gas) passes out from under the vented cold ring through the at least one through-hole in the vented cold ring. By passing through the at least one through-hole in the vented cold ring, the wafer does not move to any significant degree such as it did in previously known CVD equipment and processes.

During the second throttling process the CVD film is processed. In one embodiment the CVD film is densified. In one embodiment the CVD film is oxidized. In one embodiment the CVD film is nitrided. In one embodiment the CVD film is oxynitrided. In one embodiment the CVD film is annealed. In one embodiment the CVD film is treated to a combination of the above processes.

In one embodiment the CVD film is densified by the use of hydrogen and nitrogen in a plasma environment. Before the second throttling, the gas purge is discontinued.

After processing according to an embodiment, the wafer is removed from the CVD chamber for further processing, if any. A subsequent wafer is then able to be processed as set forth herein.

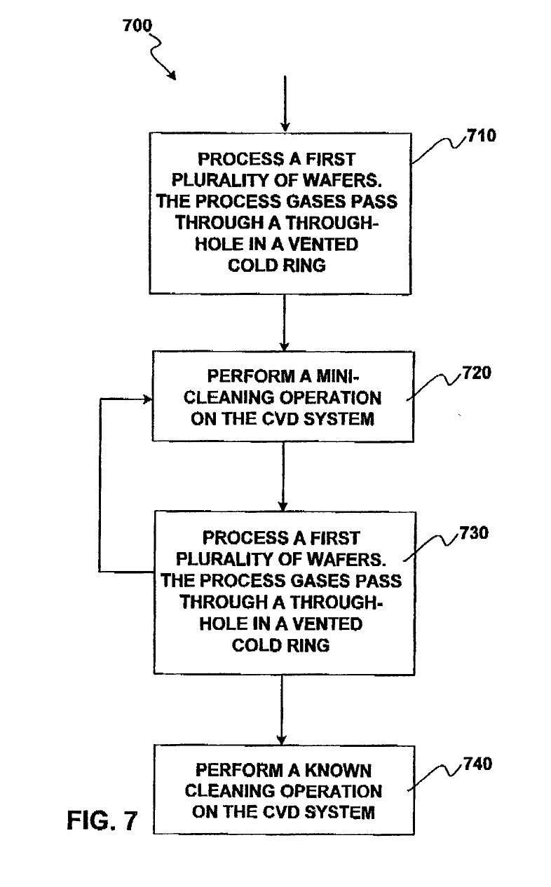

FIG. 7 is a method flow diagram 700 according to an embodiment. Because of the vented cold ring and its effect on a reduced amount of build-up, a cleaner and higher-throughput process is achieved.

At 710 a first plurality of wafers is CVD processed. The processing includes forming a CVD film, and processing the CVD film according to embodiments set forth herein.

At 720, a mini-clean operation is performed on the cold ring system. In the mini-clean operation, the vented cold ring is separated from the wafer chuck. The CVD buildup is removed from the wafer chuck. In one embodiment, the CVD buildup is removed by cleansing with a scrubbing article such as a Wilshire™ SCRUBPAD® cleansing pad made by Foamex Asia of Carlsbad, Calif. The mini-clean includes a wiping process that is carried out by wiping the wafer chuck and the heater with a cleansing fluid. According to one embodiment, the cleanser fluid is a Wilshire foam, manufactured by Foamex Asia of Carlsbad, Calif. The wiping process is continued by wiping the wafer chuck and the heater with a solvent such as isopropyl alcohol.

At 730, the vented cold ring is reinstalled, and a subsequent plurality of wafers is processed. Alternatively, after the subsequent plurality of wafers is processed, another mini-clean operation is carried out. In this embodiment, another subsequent plurality of wafers is processed. According to this embodiment, a third plurality of wafers is processed before the CVD chamber is broken down and a conventional cleaning operation is carried out as is known in the art at 740.

At 740, after the final subsequent plurality of wafer is processed, the CVD chamber is broken down, and a conventional cleaning operation is carried out as is known in the art.

In one embodiment, the first plurality of wafers is processed in a number range from about 4,000 to about 12,000 wafers. Thereafter, the mini-clean operation is carried out as set forth herein. Next the second plurality of wafers is processed in a number range from about 4,000 to about 12,000 wafers. Next, the CVD chamber is broken down, and a conventional cleaning operation is carried out as is known in the art.

In one embodiment, after a series of processes have been completed, a new vented cold ring is installed. Installation of the new vented cold ring can follow the mini-cleaning operation, or it can follow the conventional cleaning operation.

In a first example of the method embodiment, about 10,200 wafers were processed. At about the 9,000^{th} wafer, the particle count was recorded at 10. At about the 10,200^{th} wafer, the particle count was at a high of 15. At this stage of the method, the mini-clean was performed. Thereafter, the CVD chamber was reassembled with the vented cold ring, and processing continued until a total of about 15,000 wafers was processed. Except for the particle count of 10 and 15, no particle count on any wafer exceeded 8, and with the exception of five individual wafer particle counts (including the 10-count and 15-count wafers), no particle count exceeded 5 particles. Further, with the exception of seven individual wafer particle counts (including the 10-count, the 15-count, an 8-count, a 7-count, a 6-count, and two 5-count wafers, no particle count exceeded 4 particles. Further, of all the particles counted above 1, only 15 wafers had higher particle counts before the mini-clean. Similarly, of all the particles counted above 1 after the mini-clean, only 9 wafers had higher particle counts.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A cold ring comprising:
a washer upper section including an upper surface and a lower surface; and
an annular lower section including an inner surface and an outer surface, wherein the washer upper section is substantially orthogonal to the annular lower section, and wherein the annular lower section includes at least one through-hole.

2. The cold ring according to claim 1, wherein the washer upper section includes a characteristic width, wherein the annular lower section includes a characteristic height, and wherein the characteristic height is greater than the characteristic width.

3. The cold ring according to claim 1, wherein the at least one through-hole includes a plurality of through-holes, and wherein the plurality of through-holes includes a plurality of through-hole sizes.

4. The cold ring according to claim 1, wherein the at least one through-hole includes a plurality of through-holes, wherein the plurality of through-holes includes one of uniformly spaced holes, uniformly spaced incrementally sized holes, uniformly spaced groups of same-sized holes, uniformly spaced groups of same-sized holes in incremental hole-sized groups, grouped same-sized holes, uniformly spaced grouped same-sized holes, upper and lower holes, at least one slot, and combinations thereof.

5. The cold ring according to claim 1, wherein the at least one through-hole includes a plurality of through-holes in a range from about 2 to about 100 through-holes, and wherein the plurality of through-holes includes sizes that include a smallest size, a largest size, and optionally at least one intermediate size.

6. The cold ring according to claim 1, the cold ring further including:
a first fastener hole in the upper surface of the washer upper section.

7. The cold ring according to claim 1, the cold ring further including:
a first fastener hole in the upper surface of the washer upper section; and
a second fastener hole in the lower surface of the washer upper section.

8. The cold ring according to claim 1, the cold ring further including:
a first fastener hole in the upper surface of the washer upper section;
a prominence in the lower surface of the washer upper section; and
a second fastener hole in the prominence.

9. The cold ring according to claim 1, wherein the washer upper section includes a characteristic width, wherein the annular lower section includes a characteristic height, and wherein the characteristic height is greater than the characteristic width, wherein the at least one through-hole includes a plurality of through-holes, and wherein the plurality of through-holes includes a plurality of through-hole sizes, the cold ring further including:
a first fastener hole in the upper surface of the washer upper section;
a prominence in the lower surface of the washer upper section; and
a second fastener hole in the prominence.

10. A cold ring system comprising:
a cold ring, including:
a washer upper section including an upper surface and a lower surface;
an annular lower section including an inner surface and an outer surface, wherein the washer upper section is substantially orthogonal to the annular lower section, and wherein the annular lower section includes at least one through-hole;
a first support ring against the washer upper section lower surface; and
a second support ring against the first support ring.

11. The cold ring system according to claim 10, wherein the at least one through-hole includes a plurality of through-holes.

12. The cold ring system according to claim 10, wherein the at least one through-hole includes a plurality of through-holes, and wherein the plurality of through-holes includes a plurality of through-hole sizes.

13. The cold ring system according to claim 10, the cold ring further including:
a prominence on the lower surface of the washer upper section;
a first fastener hole in the upper surface; and
a second fastener hole in the prominence.

14. The cold ring system according to claim 10, the cold ring further including:
a prominence on the lower surface of the washer upper section;
a first fastener hole in the upper surface of the washer upper section;
a second fastener hole in the prominence;
a first spacer surrounding the prominence and between a first support ring and the lower surface, wherein the prominence terminates within the first support ring; and
a second spacer between the first support ring and the second support ring.

15. The cold ring system according to claim 10, the cold ring further including:
a prominence on the lower surface;
a first fastener hole in the upper surface;
a first vented fastener in the first fastener hole;
a second fastener hole in the prominence; and
a second vented fastener in the second fastener hole.

16. A process comprising:
in a chemical vapor deposition (CVD) chamber, and at a first pressure, first throttling a first gas to the CVD chamber, wherein the first gas passes through a through-hole in a vented cold ring; and
at a second pressure, second throttling a second gas, wherein the second gas passes through the through-hole.

17. The process according to claim 16, the first throttling including a CVD process, the process further including:
evacuating the CVD chamber to a milliTorr atmosphere;
transferring a wafer to the CVD chamber;
forming a CVD film during the first throttling; and
processing the CVD film during the second throttling.

18. The process according to claim 16, the first throttling including a CVD process, the process further including:
evacuating the CVD chamber to a milliTorr atmosphere;
transferring a wafer to the CVD chamber from an atmosphere that is from a 10⁻⁸ Torr to a milliTorr atmosphere;
forming a CVD film during the first throttling, wherein the CVD film is selected from a metal, a metal compound, and a dilectric; and
processing the CVD film during the second throttling, wherein processing includes one of densifying, nitriding, oxidizing, oxynitriding, annealing, and combinations thereof.

19. The process according to claim 16, the first throttling including a CVD process, the process further including:
evacuating the CVD chamber to a milliTorr atmosphere;
transferring a wafer to the CVD chamber from an atmosphere that is a 10⁻⁸ Torr atmosphere to a milliTorr atmosphere;
forming a CVD film during the first throttling, wherein the CVD film is selected from 0, N, C, Al, Cu, Ti, Zr, Hf, V, Nb, Ta, Cr, Mo, W, Co, Rh, Ir, Ni, Pd, Pt, and wherein the film forms a compound selected from a metal, a conductor, a semiconductor, a dielectric, a carbide, a nitride, a silicide, an oxide, a nitride carbide, an oxynitride, a nitride silicide, a carbide oxide, a carbide silicide, an oxynitride, a nitride silicide, an oxysilicide, an oxynitride silicide, an oxynitride carbide, an oxycarbide silicide, a nitride carbide silicide, and an oxysilicide carbide; and
processing the CVD film during the second throttling, wherein processing includes one of densifying, nitriding, oxidizing, oxynitriding, annealing, and combinations thereof.

20. The process according to claim 16, the first throttling including a CVD process, the process further including:
evacuating the CVD chamber to about a milliTorr atmosphere;
transferring a wafer to the CVD chamber from an atmosphere that is from a 10⁻⁸ Torr atmosphere to a milliTorr atmosphere;
forming a CVD film during the first throttling, wherein the first throttling is in a range from about 1.4 Torr to about 1.6 Torr; and
processing the CVD film during the second throttling, wherein the second throttling is in a range from about 1.2 Torr to about 1.3 Torr, and wherein processing the CVD film includes one of densifying, nitriding, oxidizing, oxynitriding, annealing, and combinations thereof.

21. The process according to claim 16 wherein, during the first throttling, the CVD chamber includes a wafer chuck, the wafer chuck disposed on a heater, the wafer chuck and heater in contact with the vented cold ring, the vented cold ring including a washer upper section and an annular lower section, the process further including:
directing a purge gas past the vented cold ring under conditions to resist CVD buildup on the wafer chuck and the vented cold ring; and
throttling the first gas through the vented cold ring.

22. A method comprising:
in a chemical vapor deposition (CVD) chamber, CVD processing a first plurality of wafers, wherein the CVD chamber includes a vented cold ring, the vented cold ring including a washer upper section and an annular lower section, wherein the annular lower section includes at least one through-hole: after CVD processing the first plurality of wafers, performing a first cleaning operation on the CVD chamber;
after performing the first cleaning operation on the CVD chamber, CVD processing a subsequent plurality of wafers; and
after processing the subsequent plurality of wafers, performing a subsequent cleaning operation on the CVD chamber.

23. The method according to claim 22 wherein, in CVD processing the first plurality of wafers, the first plurality of wafers is in a range from about 4,000 to about 12,000.

24. The method according to claim 22 wherein, in CVD processing the first plurality of wafers, the first plurality of wafers is in a range from about 4,000 to about 12,000, and wherein, in CVD processing the subsequent plurality of wafers, the subsequent plurality of wafers is in a range from about 4,000 to about 12,000.

25. The method according to claim 22 wherein, in CVD processing the first plurality of wafers, the CVD chamber further includes a wafer chuck, and wherein performing the first cleaning operation includes:
scrubbing CVD buildup from the wafer chuck; and
wiping the wafer chuck with a cleansing fluid.

26. The method according to claim 22 wherein, in CVD processing the first plurality of wafers, the CVD chamber further includes a wafer chuck on a heater, and wherein performing the first cleaning operation includes:
separating the vented cold ring from the wafer chuck;
removing CVD buildup from the wafer chuck;
wiping the wafer chuck with a cleansing fluid;
wiping the heater with a cleansing fluid; and
reinstalling a cold ring.

27. The method according to claim 22 wherein, in CVD processing the first plurality of wafers, the CVD chamber further includes a wafer chuck on a heater, and wherein performing the first cleaning operation includes:
separating the vented cold ring from the wafer chuck;
removing CVD buildup from the wafer chuck with a scrub pad;
wiping the wafer chuck with a foam-and-alcohol cleansing fluid;
wiping the heater with a foam-and-alcohol cleansing fluid; and
reinstalling a cold ring.
